(19) United States
(12) Patent Application Publication
(10) Pub. No.: US 2010/0110229 A1
(43) Pub. Date: May 6, 2010

(54) Terminal having photographing function and display method for the same

(75) Inventors: Stanley Chung, Seoul (KR); Jung-hyun Shim, Seongnam-si (KR); Sang-wook Park, Yongin-si (KR); Chang-su Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/654,794

(22) Filed: Jan. 4, 2010

Related U.S. Application Data
(62) Division of application No. 11/892,649, filed on Aug. 24, 2007.

(30) Foreign Application Priority Data
Oct. 2, 2006 (KR) 10-2006-0097443

(51) Int. Cl. H04N 5/76; H04N 5/222

(52) U.S. Cl. 348/231.2; 348/333.01; 348/E05.022; 348/E05.031

(57) ABSTRACT

Provided are a terminal having a photographing function and a displaying method for the terminal. The displaying method includes generating a plurality of process images by processing an original image, which is an image shown through a lens of the terminal, several times using different setup information each time, and displaying the generated plurality of process images on a plurality of buttons. Accordingly, even when a user is not proficient with how to obtain a high quality photograph by setting setup information, such as a focus, exposure, etc. and with operating the buttons, the user can select a process image, which seems to be the most preferable to the user, from among the process images, and thus the user can easily find the optimum setup information with a simple button operation.

### CROSS-REFERENCE TO RELATED PATENT APPLICATION

This application is a Divisional application Ser. No. 11/892,649, filed Aug. 24, 2007, the disclosure of which is incorporated herein in its entirety by reference. This application claims the benefit of Korean Patent Application No. 10-2006-0097443, filed on Oct. 2, 2006, in the Korean Intellectual Property Office, the disclosure of which is incorporated herein in its entirety by reference.

### BACKGROUND OF THE INVENTION

1. Field of the Invention

The present invention relates to a terminal such as a digital camera, and more particularly, to a terminal having a button capable of displaying an image, and a displaying method for the terminal.

2. Description of the Related Art

A terminal such as a digital camera, generally includes a plurality of buttons. Hence, a user can select a certain function from among various functions, such as a focus regulating function, an iris regulating function, a shutter speed regulating function, and a flash on/off setting function, that can be performed by the terminal by operating the buttons. Accordingly, the terminal performs the selected certain function.

As a result, as the number of functions that can be performed by the terminal increases, the number of button operations also increases in order to select a certain function. Considering that a digital camera which can perform various functions, such as a music reproducing function, a movie reproducing function, an Internet surfing function, etc. is more competitive in the market than a digital camera which can only perform a photographing function, the number of button operations will increase more under the current button system.

Also, as the number of functions that can be performed by the terminal increases, the number of uses of each button also increases. Accordingly, the size of characters marked on the surface of a button for showing the uses of the button will decrease, and thus a user with bad eyesight will have difficulty in regulating each button.

The terminal may have a large number of buttons in order to reduce the number of button operations, but considering a current trend of pursuing miniaturized products, the size of the buttons on the terminal should decrease, and thus it may be difficult to operate the buttons.

### SUMMARY OF THE INVENTION

The present invention provides a terminal having a photographing function and a plurality of buttons, which enables a user to easily operate the buttons while photographing an image, and a displaying method for the terminal.

The present invention also provides a terminal having a photographing function and a plurality of buttons, which enables a user to easily operate the buttons while storing a photographed image for a easy search afterwards, and a displaying method for the terminal.

The present invention also provides a terminal having a photographing function and a plurality of buttons, which enables a user to easily operate the buttons while editing a photographed image, and a displaying method for the terminal.

According to an aspect of the present invention, there is provided a terminal having a photographing function including: an image processor which generates a plurality of images by processing an image that is to be photographed according to a plurality of different preset setup information; and a plurality of displaying units which display the images generated by the image processor.

According to another aspect of the present invention, there is provided a displaying method performed in a terminal having a photographing function, the displaying method including: generating a plurality of images by processing an image that is to be photographed according to a plurality of different preset setup information; and displaying the generated plurality of images on a plurality of displaying units of the terminal.

According to another aspect of the present invention, there is provided a terminal having a photographing function including: a plurality of buttons which display a plurality of tags represented in a plurality of pieces of pre-prepared tag information; a tag information matching unit which matches a photographed image with tag information showing a tag displayed by a manipulated button from among the plurality of buttons; and a photograph storage unit which stores the photographed image with the tag information matched with the photographed image.

According to another aspect of the present invention, there is provided a displaying method performed in a terminal having a photographing function and a plurality of buttons, the displaying method including: displaying a plurality of tags represented in a plurality of pieces of pre-prepared tag information on the buttons; matching a photographed image with tag information representing a tag displayed by a manipulated button from among the buttons; and storing the photographed image with the tag information matched with the photographed image.

According to another aspect of the present invention, there is provided a terminal having a photographing function including: a plurality of buttons which display a representative image of each of a plurality of photographed images in response to a control signal; and a controller which generates the control signal that determines a button in which the representative image is displayed from among the buttons for each of the representative images, correspond to a result of manipulating at least some of the buttons.

According to another aspect of the present invention, there is provided a displaying method performed in a terminal having a photographing function and a plurality of buttons, the displaying method including: determining a button, in which a representative image of each of a plurality of photographed images to be displayed, from among the buttons for each of the representative images of the photographed images, in correspondence with a result of manipulating at least some of the buttons; and displaying each of the representative images on the each of the determined buttons.

### BRIEF DESCRIPTION OF THE DRAWINGS

The patent or application file contains at least one drawing executed in color.

Copies of this patent or patent application publication with color drawing(s) will be provided by the Office upon request and payment of the necessary fee. The above and other features and advantages of the present invention will become more apparent by describing in detail exemplary embodiments thereof with reference to the attached drawings in which:

FIG. 1 is a block diagram of a terminal having a photographing function according to an embodiment of the present invention;

FIGS. 2 and 3 are diagrams for describing a terminal having a photographing function and a displaying method for the terminal according to an embodiment of the present invention;

FIG. 4 is a flowchart of a displaying method according to an embodiment of the present invention;

FIG. 5 is a block diagram of a terminal having a photographing function according to another embodiment of the present invention;

FIG. 6 is diagrams for describing a terminal having a photographing function and a displaying method for the terminal according to another embodiment of the present invention;

FIG. 7 is a flowchart of a displaying method according to another embodiment of the present invention;

FIG. 8 is a block diagram of a terminal having a photographing function according to another embodiment of the present invention;

FIG. 9 is diagrams for describing a terminal having a photographing function and a displaying method for the terminal according to another embodiment of the present invention; and

FIG. 10 is a flowchart of a displaying method according to another embodiment of the present invention.

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described more fully with reference to the accompanying drawings, in which exemplary embodiments of the invention are shown.

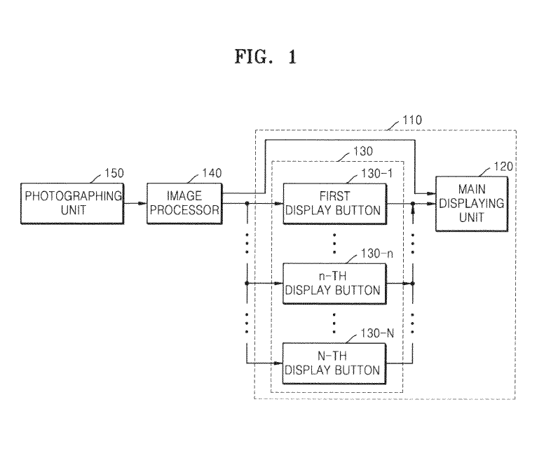

FIG. 1 is a block diagram of a terminal having a photographing function according to an embodiment of the present invention. The terminal includes a displaying unit 110, an image processor 140, and a photographing unit 150.

The displaying unit 110, the image processor 140, and the photographing unit 150 are included in a terminal such as a digital camera. For convenience, hereinafter, the terminal has a photographing function.

The displaying unit 110 may be realized using at least one display panel, such as a liquid crystal display (LCD) panel, and an image is displayed through the display panel. For convenience of description, the displaying unit 110 in the present embodiment uses one display panel.

The displaying unit 110 includes a main displaying unit 120 and a sub-displaying unit 130. That is, the entire area of the displaying unit 110 can be defined as a first portion of an area and a second portion of the area, and in this case, the first portion of the area is an area in which the main displaying unit 120 displays an image, and the second portion of area is an area in which the sub-displaying unit 130 displays an image. Here, the first portion of the area may be larger than the second portion of the area.

The main displaying unit 120 displays an image outside the terminal (hereinafter, referred as an original image) that can be photographed by the terminal. In detail, the original image is an image outside the terminal seen through a lens of the terminal.

The terminal may include a plurality of buttons. Here, the buttons may be buttons having a displaying function (hereinafter, referred to as display buttons), or buttons not having a displaying function (hereinafter, referred to as non display buttons).

The sub-displaying unit 130 may be realized using the display buttons 130-1 through 130-n, and 130-n through 130-N. Here, 1≦n≦N and N is an integer equal to 2 or above. In detail, the sub-displaying unit 130 may be integrated with the buttons 130-1 through 130-n, and 130-n through 130-N, that is, with a first display button 130-1 through an N-th display button 130-N.

The image processor 140 generates a plurality of process images by processing the original image several times using different setup information each time. The setup information is information that should be set up in order for the terminal to perform a photographing function. The setup information includes a value showing how much the iris is opened or closed (hereinafter, referred to as an opening and closing value of the iris), a shutter speed value, an exposure value, focus depth (that is, depth of field) value, and information about whether a flash is turned on or off. For example, if the image processor 140 generates 5 process images by processing the original image 5 times, each time varying the setup information comprised of the exposure value and the focus depth value, the 5 pieces of setup information may be (exposure value, focus depth value)=(a1, b1), (a2, b2), (a3, b3), (a4, b4), (a5, b5). Here, a1, a2, a3, a4, and a5 are different from each other and b1, b2, b3, b4, and b5 are also different from each other.

When the setup information can be changed by manipulating hardware of the terminal, for example, when the setup information includes the opening and closing value of the iris, the shutter speed value, etc., the image processor 140 can change the setup information if a user actually manipulates hardware, for example, the iris or the shutter. However, it is preferable to predict and define that “the original image changes when hardware is manipulated” and change the setup information according to a preset algorithm based on such definition. Accordingly, the image processor 140 may change the setup information through software. In other words, the image processor 140 generates a process image by changing the setup information through software, not by changing the setup information by manipulating hardware.

In order to obtain a high quality photograph, the setup information set in the terminal should be setup information (hereinafter, referred to as optimum setup information) that is most suitable for the environment at the time a user wants to take a photograph. In other words, in order to obtain a high quality photograph using a conventional digital camera, the user should be aware of how to obtain a high quality photograph by setting the setup information, such as focus, the amount of exposure, etc. Accordingly, a beginner, who is ignorant about setting the setup information in order to obtain a high quality photograph, is unable to obtain a satisfactory photograph using a conventional digital camera. Moreover, a user using the conventional digital camera should photograph an image several times by roughly changing the setup information several times in order to find the optimum setup information, and thus the user should go through a number of troublesome button operations.

However, the terminal according to the current embodiment employs the display buttons 130-1 through 130-N, and thus can resolve the disadvantages of a conventional digital camera described above. In other words, the display buttons 130-1 through 130-N displays the process images, and thus even a user, who is ignorant about how the original image would change according to the changed setup information, can select a process image that looks preferable from among the process images that are visually recognized. Accordingly, the optimum setup information can be easily found. Also, the display buttons 130-1 through 130-N simultaneously display the process images, and thus the user can compare various effects of setup information at the same time. Accordingly, the user can easily find the optimum setup information without troublesome button operations.

The user can operate one display button from among the display buttons 130-1 through 130-N which display a plurality of process images. That is, the user can select one process image from among the displayed process images. Here, operating a button may mean pushing a button or touching a button.

As such, when one process image is selected from the displayed process images, the main displaying unit 120 enlarges and displays the selected process image and the terminal is automatically set according to setup information matched to the selected process image.

As described above, when the user desires to photograph the original image, the user may push a shutter button after selecting one process image from among the process images generated by processing the original image and setting the terminal according to the setup information matched with the selected process image. Accordingly, even a beginner can take a high quality photograph.

However, when the setup information includes information about whether a flash is turned on or off, the image processor 140 may operate after photographing the original image with the flash on and off..

This is because changes occurring to the original image by the flash are largely affected by the performance of the flash, and thus the prediction may be inaccurate. Also, it is better to express the setup information in various values than two values of “flash on” and “flash off”.

In detail, the photographing unit 150 photographs the original image both with the flash on (a first photograph) and off (a second photograph). Then, the image processor 140 generates the process images by blending the first photograph and the second photograph several times. Here, the image processor 140 may vary a blending ratio of the first photograph and the second photograph each time they are blended.

For example, when the image processor 140 generates 5 process images (a first process image through a fifth process image) by processing the original image according to 5 different pieces of setup information formed of the information about whether a flash is turned on or off, the image processor 140 may operate as follows.

The image processor 140 may generate the first process image by blending the first and second photographs in a ratio of 90:10 (c1=0.9*a+0.1*b), the second process image by blending the first and second photographs in a ratio of 70:30 (c2=0.7*a+0.3*b), the third process image by blending the first and second photographs in a ratio of 50:50 (c3=0.5*a+0.5*b), the fourth process image by blending the first and second photographs in a ratio of 30:70 (c4=0.3*a+0.7*b), and the fifth process image by blending the first and second photographs in a ratio of 10:90 (c5=0.1*a+0.9*b). Here, a, b, c1, c2, c3, c4, and c5 are respectively a pixel value of the first photograph, a pixel value of the second photograph, a pixel value of the first process image, a pixel value of the second process image, a pixel value of the third process image, a pixel value of the fourth process image, and a pixel value of the fifth process image. Also, a, b, c1, c2, c3, c4, and c5 are pixel values of pixels at the same location in the first photograph, the second photograph, the first process image, the second process image, the third process image, the fourth process image, and the fifth process image.

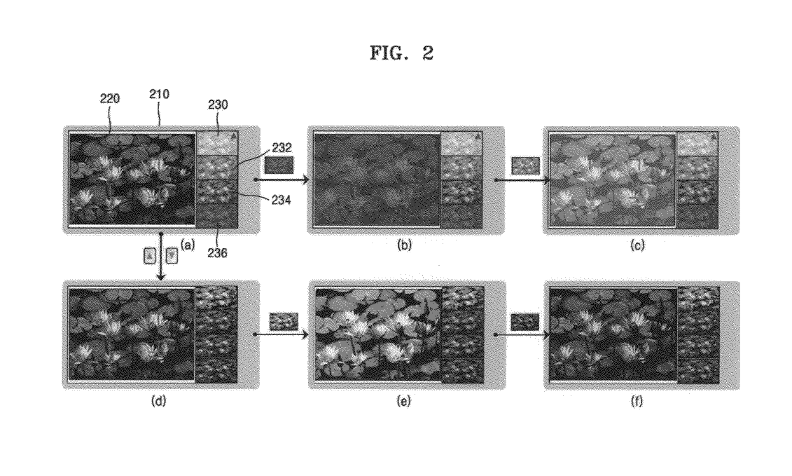

FIGS. 2 and 3 are diagrams for describing a terminal 210 having a photographing function and a displaying method for the terminal 210 according to an embodiment of the present invention. As illustrated in FIGS. 2 and 3, N is 4, a main displaying unit 220 corresponds to the main displaying unit 120 illustrated in FIG. 1, and a plurality of display buttons 230 through 236 correspond to the display buttons 130-1 through 130-N.

In detail, FIG. 2 is a diagram when setup information does not include information about whether a flash is turned on of off.

Referring to FIG. 2(a), the main displaying unit 220 displays an original image, the image processor 140 illustrated in FIG. 1 generates 4 process images by processing the original image 4 different times, and the display buttons 230 through 236 display the 4 process images.

In FIG. 2(a), a user can operate the display button 236, and accordingly, the main displaying unit 220 displays the process image displayed on the display button 236 as illustrated in FIG. 2(b). Here, the terminal 210 is automatically set according to setup information matched to the display button 236.

Similarly, the user can operate the display button 232 from FIG. 2(b), and accordingly, the main displaying unit 220 displays the process image displayed on the display button 232 as illustrated in FIG. 2(c). Here, the terminal 210 is automatically set according setup information matched to the display button 232.

Alternatively, in FIG. 2(a), the image processor 140 generates M process images by processing the original image M different times, wherein M is an integer and M>4, and the display buttons 230 through 236 simultaneously display 4 process images from among M process images.

In this case, the user may scroll through the M process images by touching the display buttons 230 through 236. In detail, the display buttons 230 through 236 are arranged in a row, and the user can scroll through the M process images by rubbing the display buttons 230 through 236 in one direction, for example, upward, or in another direction, for example, downward. Accordingly, the display buttons may be integrated with at least one touch sensor. For example, each of the display buttons 230 through 236 may include a touch sensor.

As described above, the user may scroll through the M process images by touching the display buttons 230 through 236. Alternatively, the user may scroll through the M process images by operating a scroll button, such as a direction key. Here, the scroll button may be a non display button, for example, a non display button with an arrow, or a display button, for example, a display button displaying an arrow. Hereinafter, it is assumed that the user can scroll through the M process images by operating a scroll button, which is a non display button, when the number of process images that the display buttons 230 through 236 display is M.

Accordingly, when the user operates a scroll button, such as a direction key (Δ or ∇), in FIG. 2(a), the process images displayed by the display buttons 230 through 236 are renewed as illustrated in FIG. 2(d).

Here, the user can operate the display button 230 from FIG. 2(d), and accordingly, the main displaying unit 220 displays the process image displayed on the display button 230 as illustrated in FIG. 2(e). At this time, the terminal 210 is automatically set according to setup information matched to the display button 230.

Similarly, the user can operate the display button 236 from FIG. 2(e), and accordingly, the main displaying unit 220 displays the process image displayed on the display button 236 as illustrated in FIG. 2(f). Here, the terminal 210 is automatically set according to setup information matched to the display button 236.

FIG. 3 is a diagram when setup information includes information about whether a flash is turned on or off.

First, the photographing unit 150 illustrated in FIG. 1 photographs the original image with the flash turned off in order to obtain a first photograph, and with the flash turned on in order to obtain a second photograph. Here, a subject of the first photograph and a subject of the second photograph are the same.

The image processor 140 generates 4 process images by blending the first and second photographs while varying a blending ratio of the first and second photographs 4 times. The display buttons 230 through 236 display the 4 process images as illustrated in FIG. 3(a), (b), or (c). Alternatively, the image processor 140 generates M process images by blending the first and second photographs while varying a blending ratio of the first and second photographs M times, the display buttons 230 through 236 simultaneously display 4 process images from among M process images, and the user can scroll through the M process images by manipulating a scroll button 238 or 240, such as a direction key.

The user may select one process image from among the 4 displayed process images, and then the main displaying unit 220 enlarges and displays the selected process image. If the user operates the display button 230 D1 in FIG. 3(a), the main displaying unit 220 enlarges and displays the process image displayed on the display button 230 D1. Similarly, when the user operates the display button 232 D2 in FIG. 3(b), the main displaying unit 220 enlarges and displays the process image displayed on the display button 232 D2.

Accordingly, the user can easily and instinctively decide how much flash effect is to be applied to the original image.

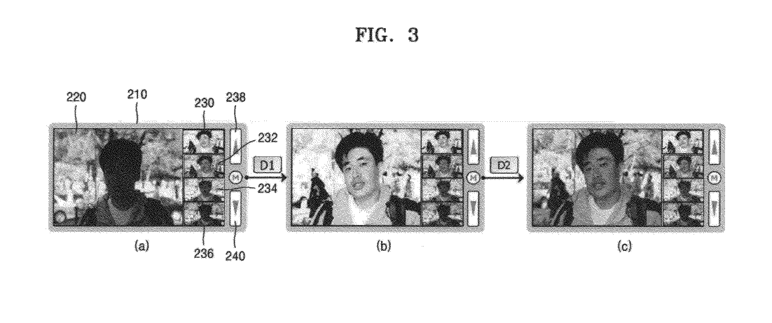

FIG. 4 is a flowchart of a displaying method according to an embodiment of the present invention. The displaying method includes operations 410 through 430 which enable a user, who wants to photograph an image using a terminal having a photographing function and a plurality of buttons, to easily operate the buttons.

In operation 410, the user presses a shutter button of the terminal about half way down so that the terminal performs a half shutter function.

Then in operation 420, an image processor generates a plurality of process images by processing an original image several times using different setup information each time.

In operation 430, the buttons displays N process images from among the process images generated in operation 420.

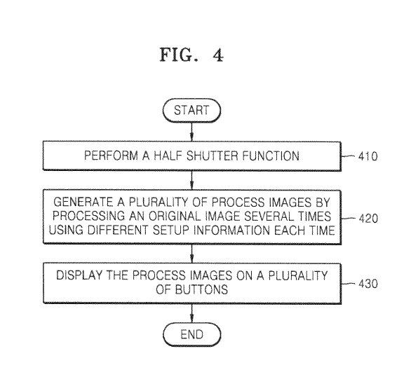

FIG. 5 is a block diagram of a terminal having a photographing function according to another embodiment of the present invention. The terminal includes a plurality of display buttons 130-1 through 130-n, and through 130-N, a photographing unit 150, a tag information reader 160, a tag information storage unit 170, a tag information matching unit 180, and a photograph storage unit 190. The display buttons 130-1 through 130-N and the photographing unit 150 illustrated in FIG. 5 are the same as the display buttons 130-1 through 130-N and the photographing unit 150 illustrated in FIG. 1, and thus details thereof will be omitted.

An image photographed by the photographing unit 150 may be stored in the terminal. Here, if the photographed image is not classified and stored according to some basis, the user may have to put in a lot of time and effort into finding a certain image from among stored images later. Accordingly, when the photographed image is to be stored, tag information, which is information for identifying a photographed image, may be matched with the photographed image, and stored with the photographed image in the terminal. When the user desires to find a tag that is to be matched with an image photographed using a conventional digital camera in the conventional digital camera, the user has to perform troublesome button operations in order to find the most suitable tag.

However, the terminal according to the current embodiment does not have the disadvantage of the conventional digital camera described above because it employs the display buttons 130-1 through 130-N. In other words, using the display buttons 130-1 through 130N displaying a plurality of tags, the user only has to operate a button, which displays a tag that the user likes, from among the buttons that the user is looking at, without operating buttons in order to find and select a suitable tag from among tags displayed on the main displaying unit 120 illustrated in FIG. 1. Accordingly, the user can easily select a tag with little button operation without moving his/her eyes to several places.

Accordingly, the tag information reader 160 reads tag information stored in the tag information storage unit 170, and the display buttons 130-1 through 130-N display tags shown by the read tag information. When the number of tags shown by the tag information is K, wherein K is an integer and K>N, the display buttons 130-1 through 130-N simultaneously display N tags, and the user can scroll through K tags by operating a scroll button, such as a direction key.

The user can select one tag by operating one of the display buttons 130-1 through 130-N. In this case, the tag information matching unit 180 matches an ‘image that is to be stored’ with lag information showing the selected tag'. Then, the photograph storage unit 190 stores the ‘image that is to be stored’ with the ‘tag information showing the selected tag’ matched to the ‘image that is to be stored’.

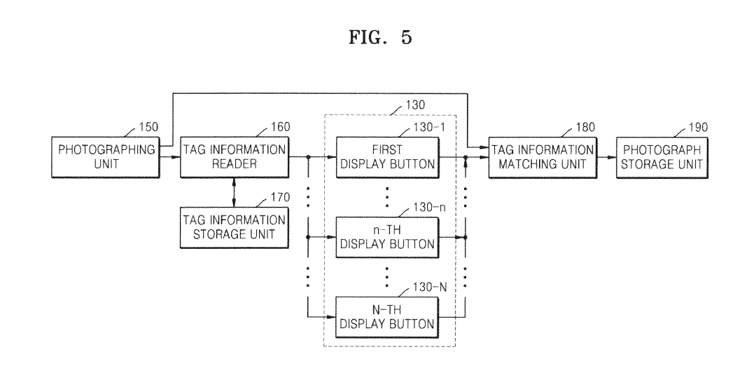

FIG. 6 is diagrams for describing a terminal 210 having a photographing function and a displaying method for the terminal 210 according to another embodiment of the present invention.

As illustrated in FIG. 6(a), a main displaying unit 220 displays an original image, and a plurality of display buttons 230 through 236 display images that request to change setup information of a terminal 210. In FIG. 6, Flash, which is an image displayed on the display button 232, is an image that requests the terminal 210 to toggle a flash on/off. That is, when a user operates the display button 232 in FIG. 6(a), the terminal 210 toggles on/off of the flash. Also, Marco, which is an image displayed on the display button 234, is an ‘image that requests the terminal 210 to turn on a close shot function. That is, when the user operates the display button 234 in FIG. 6 (a), the terminal 210 turns on the close shot function. Meanwhile, Timer, which is an image displayed on the display button 236, is an image that requests the terminal 210 to turn on a timer function. That is, when the user operates the display button 234 in FIG. 6(a), the terminal 210 turns on the timer function.

If the user presses a shutter button (not shown) in FIG. 6(a) and photographs an original image that was displayed on the main displaying unit 220 when the shutter button was being pressed, the main displaying unit 220 displays the photographed image as illustrated in FIG. 6 (b), and the buttons 230 through 236 display 4 tags: “person,” “scenery,” “inanimate object,” and “custom.” As described above, the buttons 230 through 236 can display K tags, and in this case, the user can scroll through the K tags by manipulating a scroll button 238 or 240.

Meanwhile, when the user operates the display button 230 D1 as illustrated in FIG. 6(b), the display buttons 230 through 234 display the sub-tags “family,” “friend,” and “colleague,” of a selected tag, “person”, as illustrated in FIG. 6(c). As such, tag information stored in the tag information storage unit 170 of FIG. 1 may have a hierarchical structure. When the user operates the display button 232 in FIG. 6(c), the terminal matches the photographed image with tag information showing the tag, i.e. “friend”, and stores the photographed image and the matched tag information.

When the user operates the display button 236 D4 in FIG. 6(b) after connecting the terminal 210 with a computing device, such as a personal computer (PC) and letting the terminal 210 and the computing device recognize each other, the main displaying unit 220 displays tags shown by tag information stored in the computing device and the display buttons 230 through 236 display a plurality of images, which can be operated by the user who wants to select one tag, for example, Folder 2-2, from among the tags displayed on the main displaying unit 220, as illustrated in FIG. 6(d). In FIG. 6(d), Folder 1, Folder 2, Folder 2-1, and Folder 202 displayed on the main displaying unit 220 are examples of the tags shown by the tag information stored in the computing device. Here, the main displaying unit 220 displays the tag information while maintaining the hierarchical structure of the tag information stored in the computing device. Also, in FIG. 6(d), “Home” is an image requesting the main displaying unit 220 to display the top tag, and “Folder Open/Close” is an image requesting the main displaying unit 220 to display a window asking whether to open or close a folder. If the user selects “Folder Open/Close” by operating the display button 232 while “Folder 2-1” is being selected, the main displaying unit 220 displays a window asking whether to open “Folder 2-1,” that is, whether to display sub-tags, such as “Folder 2-1-1,” “Folder 2-1-2,” etc. of “Folder 2-1,” or close “Folder 2-1,” that is, whether to display upper tags, such as “Folder 2-1”, “Folder 2-2,” etc. of “Folder 2-1.” Meanwhile, “Tag” is an image requesting the terminal 210 to match a currently selected tag, for example “Folder 2-2-2,” to an image that is to be stored, and “Cancel” is an image requesting the main displaying unit 220 to display upper tags of the currently selected tag.

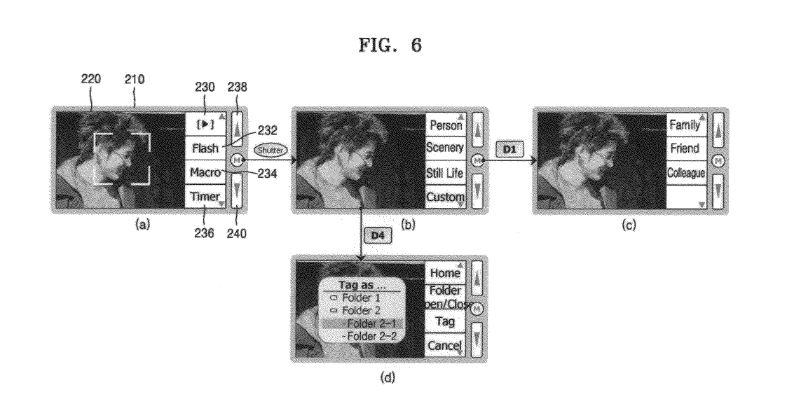

FIG. 7 is a flowchart of a displaying method according to another embodiment of the present invention. The displaying method includes operations 710 through 730 which enable a user, who desires to store an image photographed using a terminal having a photographing function and a plurality of buttons, to easily perform a button operation while searching for the image later.

In operation 710, the display buttons display a plurality of tags shown by a plurality of pieces of pre-prepared tag information.

Then, a tag information matching unit matches the photographed image to tag information showing a tag displayed by a manipulated display button from among the display buttons in operation 720.

Next, a photograph storage unit 190 stores the photographed image and the tag information matched to the photographed image in operation 730.

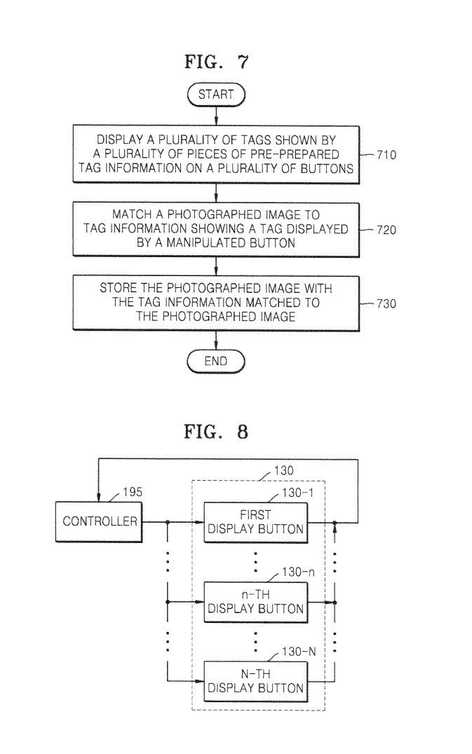

FIG. 8 is a block diagram of a terminal having a photographing function according to another embodiment of the present invention. The terminal includes a plurality of display buttons 130-1 through 130-n, and 130-n through 130-N, and a controller 195. The display buttons 130-1 through 130-N illustrated in FIG. 8 correspond to the display buttons 130-1 through 130-N illustrated in FIG. 1, and thus descriptions thereof will be omitted.

The display buttons 130-1 through 130-N display representative images corresponding to respective photographed images in response to a control signal. Hereinafter, it is assumed that the photographed images are moving pictures, and the representative image of the moving picture is an initial image of the moving picture. When the number of the photographed images, that is, the number of the representative images that is displayed by the display buttons 130-1 through 130-N, is K, the display buttons 130-1 through 130-N simultaneously display N representative images, and the user can scroll through K representative images by operating a scroll button 238 or 240.

The controller 195 generates the control signal. Here, the control signal is a signal which determines which display button from among the display buttons 130-1 through 130-N is to display a representative image for each of the K representative images.

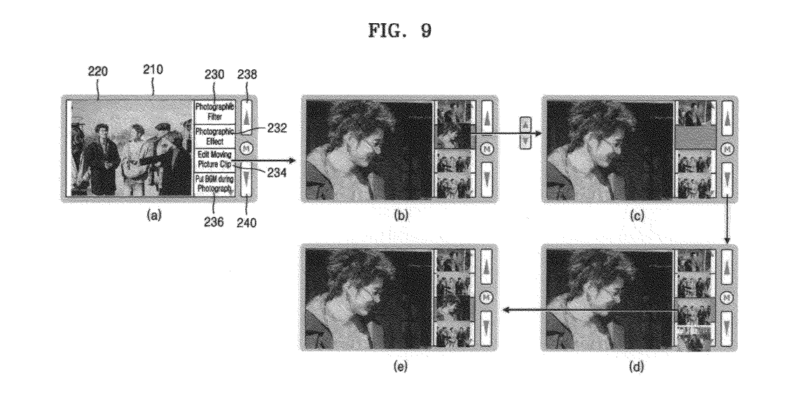

The controller 195 generates a control signal that corresponds to the result of operating a display button. Details will be described with reference to FIG. 9.

FIG. 9 is diagrams for describing a terminal 210 having a photographing function and a displaying method for the terminal 210 according to another embodiment of the present invention.

In FIG. 9(a), a main displaying unit 220 displays an image that is being currently photographed, and a plurality of display buttons 230 through 236 display images requesting to change setup information of the terminal 210.

In FIG. 9(a), ‘Photographic Filter’, which is an image displayed on the display button 230, is an image requesting the terminal 210 to filter the image that is being currently photographed using a preset digital filter. That is, when a user operates the display button 230 in FIG. (a), the terminal 210 filters the image that is being currently photographed. Also, ‘Photographic Effect’, which is an image displayed on the display button 232, is an image requesting the terminal 210 to uniformly change color and luminance of the image that is being currently photographed. That is, when the user operates the display button 232 in FIG. 9(a), the terminal 210 uniformly changes the color and luminance of the image that is being currently photographed. ‘Put BGM during Photograph’, which is an image displayed on the display button 236, is an image requesting the user to insert pre-assigned music to the image that is being currently photographed. That is, when the user operates the display button 236 in FIG. 9(a), the terminal 210 informs the user about kinds of music that can be inserted into the image that is being currently photographed and asks the user to select one kind of music, while photographing the image.

Also, ‘Edit Moving Picture Clip’, which is an image displayed on the display button 234, is an image requesting the user to edit an order of reproduction of a plurality of moving picture clips. That is, the user can edit accordingly by operating the display button 234 in FIG. 9(a).

In detail, when the user operates the display button 234 in FIG. 9(a), the display buttons 230 through 236 display the representative images of moving picture files (hereinafter, referred to as clips) that can be reproduced in the terminal 210 as illustrated in FIG. 9(b). As described above, when the number of representative images that is to be displayed by the display buttons 230 through 236 is M, the display buttons 230 through 236 simultaneously display N representative images, and the user can scroll through M representative images by operating a scroll button 238 or 240.

When the user operates the display button 232 in FIG. 9(b), the display of a representative image (hereinafter, referred to as a target image) displayed on the display button 232 from among the 4 representative images displayed on the buttons 230 through 236 is selected, and the main displaying unit 220 enlarges and displays the selected target image as illustrated in FIG. 9(b).

In this case, the user can change one of display buttons 230 through 236 displaying the selected target image, by operating the scroll button 240, as illustrated in FIGS. 9(b), (c), and (d).

Alternatively, the user can change one of display buttons 230 through 236 displaying the selected target image, by operating the display buttons 230 through 236, as illustrated in FIGS. 9(b), (c), and (d). In detail, the user touches the display buttons 232 through 236 in an order of the display button 232, the display button 234, and the display button 236 in order to change one of display buttons 230 through 236 displaying the selected target image as illustrated in FIGS. 9(b), (c), and (d). Accordingly, the display buttons 230 through 236 may include touch sensors.

As illustrated in FIGS. 9(b) and (c), the user can direct the display button 234 to display the selected target image by operating the scroll button 240 or touching the display buttons 232 through 236. In this case, the representative image displayed on the display button 234 in FIG. (c) is displayed on the display button 236 as illustrated in FIG. 9(d). Accordingly, the representative image displayed on the displayed button 236 in FIG. 9(c) is not displayed on any of the display buttons 230 through 236 as illustrated in FIG. 9(d).

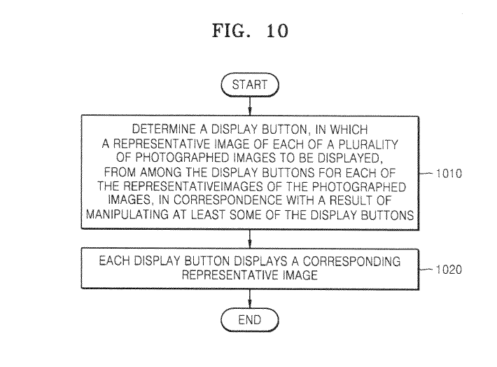

FIG. 10 is a flowchart of a displaying method according to another embodiment of the present invention. The displaying method includes operations 1010 through 1020 which enable a user, who desires to edit an image photographed using a terminal having a photographing function and a plurality of display buttons, to easily operate the display buttons.

In operation 1010, a controller determines a display button, in which a representative image of each of a plurality of photographed images to be displayed, from among the display buttons for each of the representative images of the photographed images, according to the result of operating at least some of the display buttons.

In operation 1020, each display button determined in operation 1010 displays a corresponding representative image. The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, the terminal having a photographing function and a plurality of buttons, and the displaying method for the terminal according to the present invention enable a user, who wants to photograph an image using the terminal, to easily operate the buttons. In detail, the terminal generates a plurality of process images by processing an original image, which is an image seen through a lens of the terminal, several times using different setup information each time and displays the generated process images on a plurality of buttons before the user photographs an image by pressing a shutter button. Accordingly, the user can instinctively and easily recognize setup information that he/she desires. The user can easily find the setup information that he/she desires, and automatically set the focus, exposure, etc. according to the found setup information by operating a button displaying the found setup information. Consequently, even when the user is not proficient at obtaining a high quality photograph by setting the setup information, such as the focus, exposure, etc. and at operating the buttons, the user can easily find the optimum setup information with a simple button operation by selecting a process image that looks most preferable to the user from among the displayed process images.

Also, the terminal enables a user who wants to store an image photographed by the terminal for a easy search afterwards to operate the buttons easily. In detail, the terminal displays a plurality of tags shown by a plurality of pieces of pre-prepared tag information on the buttons, and matches the photographed image to tag information showing a tag displayed by a button operated by the user, and stores the photographed image with the matched tag information. Accordingly, the user only has to operate a button displaying a tag that the user likes from among buttons that the user is looking at, without operating buttons in order to find and select a suitable tag from among tags displayed on the main displaying unit, while assigning a tag that is to be matched to the photographed image. Consequently, the user can easily select a tag via a simple button operation without moving his/her eyes to several places, and thus efforts of the user to find a tag are remarkably reduced.

Moreover, the terminal enables the user, who wants to emit an image photographed using the terminal, to easily operate the buttons. In detail, the terminal determines a button, which displays a representative image corresponding to one of the photographed images, according to the result of operating the buttons, and displays the representative image on the determined button. Accordingly, when the photographed images displayed on the buttons are reproduced in an order in which the representative images are arranged, the user can easily edit the order of reproduction of the photographed images via a simple button operation.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A terminal having a photographing function comprising:
a plurality of buttons which display a plurality of tags represented in a plurality of pieces of pre-prepared tag information;
a tag information matching unit which matches a photographed image with tag information showing a tag displayed by a manipulated button from among the plurality of buttons; and
a photograph storage unit which stores the photographed image with the tag information matched with the photographed image.

2. The terminal of claim 1, wherein the pieces of tag information are pre-prepared in the terminal or a computing device which can be recognized by the terminal.

3. The terminal of claim 1, wherein the stored image can be stored in a computing device recognized by the terminal after being matched with the tag information that is matched with the stored image, from among tag information prepared in the computing device.

4. The terminal of claim 1, wherein the pieces of tag information have a hierarchical structure.

5. A displaying method performed in a terminal having a photographing function and a plurality of buttons, the displaying method comprising:
displaying a plurality of tags represented in a plurality of pieces of pre-prepared tag information on the buttons;
matching a photographed image with tag information representing a tag displayed by a manipulated button from among the buttons; and
storing the photographed image with the tag information matched with the photographed image.

6. The displaying method of claim 5, wherein the pieces of tag information are pre-prepared in the terminal or a computing device which can be recognized by the terminal.

7. The displaying method of claim 5, wherein the stored image can be stored in a computing device recognized by the terminal after being matched with the tag information that is matched with the stored image, from among tag information prepared in the computing device.

8. A terminal having a photographing function comprising:
a plurality of buttons which display a representative image of each of a plurality of photographed images in response to a control signal; and
a controller which generates the control signal that determines a button in which the representative image is displayed from among the buttons for each of the representative images, correspond to a result of manipulating at least some of the buttons.

9. The terminal of claim 8, wherein the photographed images are moving pictures.

10. A displaying method performed in a terminal having a photographing function and a plurality of buttons, the displaying method comprising:
determining a button, in which a representative image of each of a plurality of photographed images to be displayed, from among the buttons for each of the representative images of the photographed images, in correspondence with a result of manipulating at least some of the buttons; and
displaying each of the representative images on the each of the determined buttons.
